(19) United States
(12) Patent Application Publication
(10) Pub. No.: US 2021/0400255 A1
(43) Pub. Date: Dec. 23, 2021

(54) IMAGE PROCESSING APPARATUS, IMAGE PROCESSING METHOD, AND PROGRAM

(71) Applicant: SONY GROUP CORPORATION, TOKYO (JP)

(72) Inventor: KOUJI OGAWA, TOKYO (US)

(21) Appl. No.: 17/309,982

(22) PCT Filed: Dec. 27, 2019
(86) PCT No.: PCT/JP2019/051424

§ 371 Date: Jul. 7, 2021

(30) Foreign Application Priority Data
Jan. 16, 2019 (JP) 2019-005011

(51) Int. Cl. H04N 13/349; G06T 15/20; G06T 15/50; H04N 13/344

(52) U.S. Cl. CPC H04N 13/349; H04N 13/344; G06T 15/50; G06T 15/205

(57) ABSTRACT

The present technology relates to an image processing apparatus, an image processing method, and a program that enable reproduction-and-editing work for free viewpoint data to be performed easily. Generated is reproduction control information for control of reproduction of free viewpoint data generated from a plurality of viewpoint images in response to an operation on a three-dimensional (3D) strobe image including a strobe model viewed from a virtual viewpoint, in which, in the strobe model, 3D models of objects at a plurality of times being generated from the plurality of viewpoint images shot from a plurality of viewpoints are disposed in a three-dimensional space. The present technology is applicable to, for example, reproduction and editing of free viewpoint data.

### TECHNICAL FIELD

The present technology relates to an image processing apparatus, an image processing method, and a program, and particularly relates to an image processing apparatus, an image processing method, and a program that enable, for example, reproduction-and-editing work for free viewpoint data to be performed easily.

### BACKGROUND ART

There has been proposed a method of generating a strobe image showing a subject (image) shot at a plurality of times (see, for example, Patent Document 1). Such a strobe image shows a subject at a plurality of times, and thus the motion and trajectory of the subject can be grasped easily.

### CITATION LIST

### Patent Document

Patent Document 1: Japanese Patent Application Laid-Open No. 2007-259477

### SUMMARY OF THE INVENTION

### Problems to be Solved by the Invention

In recent years, there has been an increasing demand for easily performing reproduction-and-editing work regarding reproduction and editing for free viewpoint data enabling generation of a free viewpoint image in which the appearance when viewing a three-dimensional space from a virtual viewpoint is recreated.

The present technology has been made in view of such a situation, and enables reproduction-and-editing work for free viewpoint data to be performed easily.

### Solutions to Problems

An image processing apparatus or a program according to the present technology is an image processing apparatus or a program to cause a computer to function as such an information processing apparatus, and the image processing apparatus includes a reproduction control unit configured to generate reproduction control information for control of reproduction of free viewpoint data generated from a plurality of viewpoint images in response to an operation on a three-dimensional (3D) strobe image including a strobe model viewed from a virtual viewpoint, in which, in the strobe model, 3D models of objects at a plurality of times being generated from the plurality of viewpoint images shot from a plurality of viewpoints are disposed in a three-dimensional space.

An image processing method according to the present technology is an image processing method includes generating reproduction control information for control of reproduction of free viewpoint data generated from a plurality of viewpoint images in response to an operation on a three-dimensional (3D) strobe image including a strobe model viewed from a virtual viewpoint, in which, in the strobe model, 3D models of objects at a plurality of times being generated from the plurality of viewpoint images shot from a plurality of viewpoints are disposed in a three-dimensional space.

In the image processing apparatus, the image processing method, and the program according to the present technology, generated is reproduction control information for control of reproduction of free viewpoint data generated from a plurality of viewpoint images in response to an operation on a three-dimensional (3D) strobe image including a strobe model viewed from a virtual viewpoint, in which, in the strobe model, 3D models of objects at a plurality of times being generated from the plurality of viewpoint images shot from a plurality of viewpoints are disposed in a three-dimensional space.

Note that the image processing apparatus and a display device each may be an independent apparatus, or each may be an internal block included in one apparatus.

In addition, the program can be provided by being transmitted through a transmission medium, or by being recorded on a recording medium.

### BRIEF DESCRIPTION OF DRAWINGS

FIG. 1 is a block diagram illustrating an exemplary configuration of an embodiment of an image processing system with the present technology applied.

FIG. 2 is a block diagram illustrating an exemplary configuration of a content server 12.

FIG. 3 is a block diagram illustrating an exemplary configuration of a reproduction-and-editing device 13.

FIG. 4 is a flowchart explanatorily illustrating exemplary processing performed by the content server 12.

FIG. 5 is a flowchart explanatorily illustrating exemplary processing performed by the reproduction-and-editing device 13.

FIG. 6 illustrates an exemplary unnatural three-dimensional (3D) strobe image.

FIG. 7 illustrates an exemplary natural 3D strobe image.

FIG. 8 illustrates exemplary frames of a viewpoint image in a strobe section.

FIG. 9 illustrates exemplary strobe model generation with frames at times t1 to t9 as a strobe section.

FIG. 10 illustrates exemplary display of a 3D strobe image generated by shooting the strobe model with a virtual camera.

FIG. 11 explanatorily illustrates an exemplary user operation in search for a predetermined scene (frame) for free viewpoint data.

FIG. 12 explanatorily illustrates exemplary moving image content of free viewpoint data.

FIG. 13 illustrates an exemplary strobe model generated with the moving image content of free viewpoint data.

FIG. 14 explanatorily illustrates a first exemplary user operation on a 3D strobe image.

FIG. 15 explanatorily illustrates a second exemplary user operation on the 3D strobe image.

FIG. 16 explanatorily illustrates a third exemplary user operation on the 3D strobe image.

FIG. 17 explanatorily illustrates a fourth exemplary user operation on the 3D strobe image.

FIG. 18 is a table indicating an exemplary shooting scenario.

FIG. 19 explanatorily illustrates exemplary processing jump.

FIG. 20 explanatorily illustrates exemplary reproduction-and-editing work for assignation of processing link.

FIG. 21 explanatorily illustrates exemplary reproduction-and-editing work for assignation of effect processing.

FIG. 22 is a block diagram of an exemplary configuration of an embodiment of a computer with the present technology applied.

### MODE FOR CARRYING OUT THE INVENTION

### Embodiment of Image Processing System with Present Technology Applied

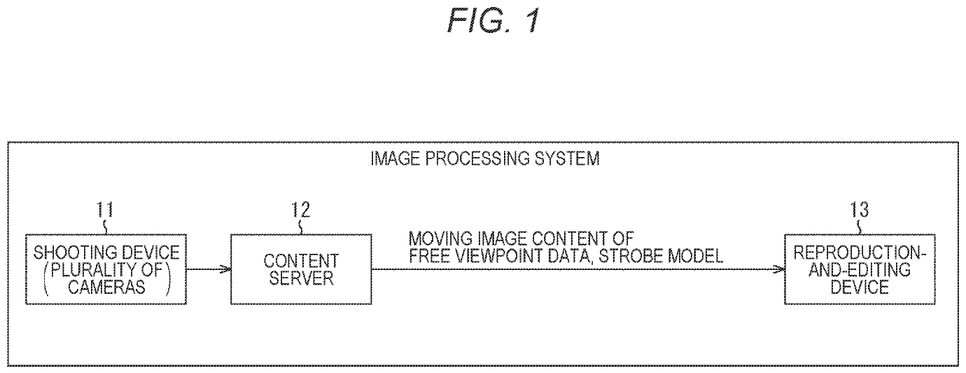

FIG. 1 is a block diagram illustrating an exemplary configuration of an embodiment of an image processing system with the present technology applied.

In the image processing system of FIG. 1, with free viewpoint data generated from live images, generated and displayed is an image viewed when viewing an object as a subject in a three-dimensional space from a predetermined viewpoint, that is, a 2D image acquired by projecting a viewing volume within a three-dimensional space represented by the free viewpoint data onto a projection plane perpendicular in the direction of line-of-sight when viewing an object from a predetermined viewpoint. This 2D image can be generated with a freely determined viewpoint and thus can be called a free viewpoint image. A viewpoint (including the direction of line-of-sight) required for generating a free viewpoint image can be virtually set regardless of the actual viewpoint of the user, and thus such a viewpoint is also referred to as a virtual viewpoint.

Similarly to the moving image content of the 2D image, the moving image content of the free viewpoint data has a degree of freedom in the direction of time, and has a degree of freedom for a virtual viewpoint, that is, the shooting position and the shooting posture (the direction of shooting) of a virtual camera that shoots (a three-dimensional space represented by) the free viewpoint data. The shooting position of the virtual camera can be represented by coordinates such as the xyz coordinate system as the world coordinate system, and the shooting posture of the virtual camera can be represented by, for example, the rotation angle around each axis in the world coordinate system. The shooting position of the virtual camera can be moved in the x-axis, y-axis, and z-axis directions, and the shooting posture of the virtual camera can be rotated around the x-axis, y-axis, and z-axis. Thus, the shooting position and the shooting posture of the virtual camera has six degrees of freedom (6 DoF). Therefore, free viewpoint data has a total of seven degrees of freedom including one degree of freedom in the direction of time and six degrees of freedom in the shooting position and the shooting posture (of the virtual viewpoint) of the virtual camera. Here, as a free viewpoint image generated by projecting (a viewing volume within a three-dimensional space represented by) free viewpoint data onto a projection plane to a virtual viewpoint, acquired can be a 2D image as if a camera that is virtual shot the free viewpoint data from the virtual viewpoint. Thus, it can be said that projecting the free viewpoint data onto the projection plane to the virtual viewpoint corresponds to shooting the free viewpoint data from the virtual viewpoint with the camera that is virtual. That is, projecting the free viewpoint data onto the projection plane to the virtual viewpoint to generate the free viewpoint image can be compared to shooting the free viewpoint data with the camera that is virtual and disposed in the virtual viewpoint. Therefore, in the present embodiment, generation of a free viewpoint image will be described appropriately by comparing to shooting of free viewpoint data with a camera that is virtual. In addition, such a camera that is virtual and shoots free viewpoint data is also referred to as a virtual camera.

The image processing system of FIG. 1 includes a shooting device 11, a content server 12, and a reproduction-and-editing device 13.

The shooting device 11 includes at least a plurality of cameras, and shoots an object from a plurality of viewpoints. For example, the plurality of cameras included in the shooting device 11 is disposed surrounding an object, and each camera shoots the object from the viewpoint as the position where the camera is disposed. The two-dimensional (2D) images shot by the cameras from the positions of the cameras, that is, the (moving images) of the viewpoint images of the plurality of viewpoints as the 2D images shot from the plurality of viewpoints are supplied from the shooting device 11 to the content server 12, on a frame basis.

Here, the shooting device 11 may be provided with a plurality of distance measuring devices in addition to the plurality of cameras. The distance measuring devices can be disposed one-to-one at the same positions (viewpoints) as the cameras, or can be disposed at the positions different from those of the cameras. The distance measuring devices each measure the distance from the position (viewpoint) where the distance measuring device is disposed to the object, and generates a depth image as a 2D image having, as pixel values, a depth as information regarding the distance. The depth images are supplied from the shooting device 11 to the content server 12.

Note that in a case where the shooting device 11 is not provided with a distance measuring device, the shooting device 11 can measure the distance to the object by the principle of triangulation with the viewpoint images of two viewpoints among the viewpoint images of a plurality of viewpoints to generate a depth image.

The content server 12 is, for example, a web server or a server on the cloud. The content server 12 generates the moving image content of the free viewpoint data with the viewpoint images of a plurality of viewpoints and the like supplied from the shooting device 11, for example. The content server 12 further generates, with the free viewpoint data, a strobe model in which the 3D models of the same object (subject) between a plurality of frames (times) of a viewpoint image are disposed in (the 3D model) of the three-dimensional space shot by the shooting device 11. In response to a request from the reproduction-and-editing device 13, the content server 12 transmits the moving image content of the free viewpoint data and the strobe model to the reproduction-and-editing device 13.

The reproduction-and-editing device 13 is, for example, a client of a personal computer (PC), a television receiver (TV), or a mobile terminal such as a smartphone, or the like. The reproduction-and-editing device 13 requests the moving image content of the free viewpoint data and the strobe model of the content server 12 to acquire them from the content server 12. In addition, in response to a user operation on a 3D strobe image including the strobe model viewed from a virtual viewpoint, the reproduction-and-editing device 13 generates reproduction control information for control of reproduction of the moving image content of the free viewpoint data. Then, the reproduction-and-editing device 13 reproduces and edits the moving image content of the free viewpoint data in accordance with the reproduction control information.

Note that the content server 12 and the reproduction-and-editing device 13 each can be provided as a separate device as illustrated in FIG. 1, or the content server 12 and the reproduction-and-editing device 13 can be integrally provided as one device (for example, a PC).

<Exemplary Configuration of Content Server 12>

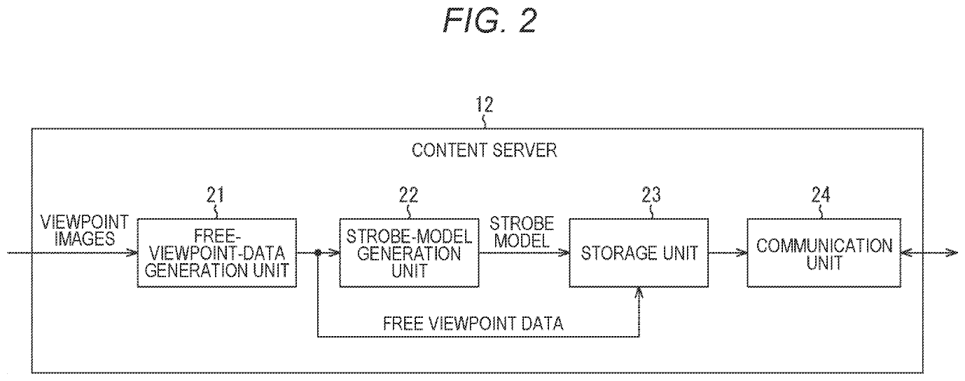

FIG. 2 is a block diagram illustrating an exemplary configuration of the content server 12 of FIG. 1.

The content server 12 includes a free-viewpoint-data generation unit 21, a strobe-model generation unit 22, a storage unit 23, and a communication unit 24.

The free-viewpoint-data generation unit 21 generates, on a frame basis, free viewpoint data from the viewpoint images of the plurality of viewpoints and the corresponding depth images from the shooting device 11 to generate the moving image content of the free viewpoint data.

Here, the free viewpoint data broadly means 3D image data (3D data) enabling generation of a free viewpoint image. As the free viewpoint data, for example, a set of the viewpoint images of the plurality of viewpoints and the corresponding depth images from the shooting device 11 can be adopted without any change. In addition, as the free viewpoint data, for example, 3D data having 3D shape models as information regarding a three-dimensional shape and color information, or a set of the 2D images of a plurality of viewpoints and the corresponding depth images can also be adopted.

In a case where the set of the viewpoint images of the plurality of viewpoints and the corresponding depth images from the shooting device 11 is adopted as free viewpoint data, the free-viewpoint-data generation unit 21 adopts, without any change, the set of the viewpoint images of the plurality of viewpoints and the corresponding depth images from the shooting device 11.

In a case where 3D data having 3D shape models and color information is adopted as free viewpoint data, the free-viewpoint-data generation unit 21 models by Visual Hull or the like with the viewpoint images of the plurality of viewpoints from the shooting device 11, generates, for example, the 3D shape model of the object showed in each viewpoint image, and adopts, as the viewpoint data, the 3D models together with the viewpoint images of the plurality of viewpoints as textures. Note that, in a case where the depth images from the shooting device 11 are different in viewpoint from the viewpoint images from the shooting device 11, the free-viewpoint-data generation unit 21 can generate, with the depth images of the plurality of viewpoints from the shooting device 11, depth images of the viewpoints of the viewpoint images from the shooting device 11.

In a case where the set of the 2D the images of the plurality of viewpoints and the corresponding depth images is adopted as free viewpoint data, the free-viewpoint-data generation unit 21 generates, for example, as described above, 3D data having 3D shape models and color information. Then, the free-viewpoint-data generation unit 21 generates, as the free viewpoint data, a set of 2D images and the corresponding depth images including the 3D data viewed from a plurality of viewpoints (may be the same as or different from viewpoints of the cameras included in the shooting device 11).

As described above, the free-viewpoint-data generation unit 21 generates the moving image content of the free viewpoint data and supplies the moving image content to the strobe-model generation unit 22 and the storage unit 23.

Note that as free viewpoint data, adoption of the set of the 2D images of the plurality of viewpoints and the corresponding depth images can reduce the amount of free viewpoint data as compared with adoption of 3D data having 3D shape models. A technique for generating and transmitting a set of the 2D images of a plurality of viewpoints and the corresponding depth images as free viewpoint data is described in International Publication No. 2017/082076 previously proposed by the applicant. A set of the 2D images of a plurality of viewpoints and the corresponding depth images as free viewpoint data can be encoded with an encoding scheme for 2D images, such as multiview and depth video coding (MVCD), advanced video coding (AVC), or high efficiency video coding (HEVC).

Here, the free viewpoint data (expression formats thereof) include a 3D model called view independent (hereinafter, also referred to as VI model) and a 3D model called view dependent (hereinafter, also referred to as VD model).

The VD model is, for example, 3D data in which information regarding a three-dimensional shape such as a 3D shape model and information regarding an image as a texture are separated. In the VD model, the 3D shape model is colored by mapping an image as a texture (texture mapping). The VD model can express the degree of reflection on the surface of an object that differs depending on the (virtual) viewpoint, for example. The VD model is called view dependent because its appearance depends on the viewpoint.

The VI model is, for example, 3D data in which polygons and points as components of information regarding a three-dimensional shape have color information. Examples of the VI model include a colored point cloud, and a set of 3D shape model and a UV map as color information of the 3D shape model. In the VI model, the colors of polygons and points are observed from any (virtual) viewpoint. The VI model is called view independent because its appearance is independent from the viewpoint.

The strobe-model generation unit 22 uses the free viewpoint data from the free-viewpoint-data generation unit 21 to generate a strobe model in which 3D models as the free viewpoint data of the same object between a plurality of frames (different times) of a viewpoint image are disposed in (the 3D model of) the three-dimensional space shown in the viewpoint image.

That is, the strobe-model generation unit 22 selects a frame for use in generation of a strobe model (hereinafter, also referred to as a generation frame) from frames in a strobe section including the frames for generating the strobe model. Furthermore, the strobe-model generation unit 22 sets at least one object of the objects shown in the generation frame, as a target object for disposing the corresponding 3D model in the strobe model (hereinafter, also referred to as the target object). Then, the strobe-model generation unit 22 generates the strobe model in which the 3D model of the target object shown in the generation frame is disposed, and supplies the strobe model to the storage unit 23.

Note that the strobe-model generation unit 22 can set, for example, all the moving objects shown in the generation frame, as target objects. In addition, the strobe-model generation unit 22 can set, for example, among the moving objects shown in the generation frame, an object specified by the user of the reproduction-and-editing device 13, as a target object.

The storage unit 23 stores the moving image content of the free viewpoint data from the free-viewpoint-data generation unit 21 and the strobe model from the strobe-model generation unit 22.

The communication unit 24 communicates with the reproduction-and-editing device 13. That is, for example, in response to a request from the reproduction-and-editing device 13, the communication unit 24 transmits the moving image content of the free viewpoint data and the strobe model stored in the storage unit 23 to the reproduction-and-editing device 13.

Note that the free-viewpoint-data generation unit 21 and the strobe-model generation unit 22 can be provided in the reproduction-and-editing device 13.

<Exemplary Configuration of Reproduction-and-Editing Device 13>

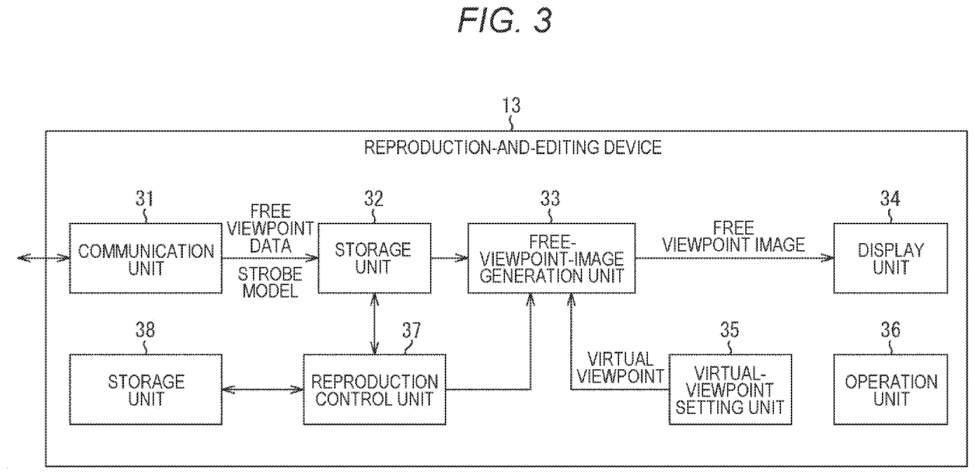

FIG. 3 is a block diagram illustrating an exemplary configuration of the reproduction-and-editing device 13 of FIG. 1.

The reproduction-and-editing device 13 includes a communication unit 31, a storage unit 32, a free-viewpoint-image generation unit 33, a display unit 34, a virtual-viewpoint setting unit 35, an operation unit 36, a reproduction control unit 37, and a storage unit 38.

The communication unit 31 communicates with the content server 12. That is, in response to an operation on the operation unit 36, the communication unit 31 transmits a request for the moving image content of the free viewpoint data and the strobe model, for example. Furthermore, in response to the request, the communication unit 31 receives the moving image content of the free viewpoint data and the strobe model transmitted from the content server 12, and supplies the moving image content of the free viewpoint data and the strobe model to the storage unit 32.

The storage unit 32 stores the moving image content of the free viewpoint data and the strobe model from the communication unit 31.

The free-viewpoint-image generation unit 33 generates (renders), as (the data of) a free viewpoint image, for example, a 2D image (2D image acquired by shooting with the virtual camera located at the virtual viewpoint) (including a set of a 2D image for the left eye and a 2D image for the right eye) including (the three-dimensional space represented by) the free viewpoint data stored in the storage unit 32 viewed from the virtual viewpoint supplied from the virtual-viewpoint setting unit 35, and supplies (the data of) the free viewpoint image to the display unit 34.

The free-viewpoint-image generation unit 33 also generates, as a free viewpoint image, a 3D strobe image (3D computer graphics (CG)) as a 2D image including the strobe model stored in the storage unit 32 viewed from the virtual viewpoint from the virtual-viewpoint setting unit 35, and supplies the free viewpoint image to the display unit 34.

Here, the strobe image is an image showing at least one same object (image) shot at a plurality of times. A strobe image showing an object shown in each 2D image is also referred to as a 2D strobe image, and a 2D image showing 3D models of the object, that is, a 2D image including the strobe model viewed from a predetermined viewpoint is also referred to as a 3D strobe image. The free-viewpoint-image generation unit 33 generates such a 3D strobe image.

The display unit 34 displays the 3D strobe image, the other free viewpoint image, or the like from the free-viewpoint-image generation unit 33.

As the display unit 34, a 2D head-mounted display, a 2D monitor, a 3D head-mounted display, a 3D monitor, or the like can be provided, for example. A 3D head-mounted display or a 3D monitor is a display device that achieves stereoscopic vision by displaying, for example, a 2D image for the left eye and a 2D image for the right eye.

The virtual-viewpoint setting unit 35 sets a virtual viewpoint for shooting a strobe model by each virtual camera, and supplies the virtual viewpoint to the free-viewpoint-image generation unit 33. The virtual viewpoint can be set in response to a user operation, for example. The user operation includes the state of the user (position and posture) and gestures, in addition to an operation on the operation unit 36 by the user. For example, in a case where a head-mounted display is provided as the display unit 34, the state of the user can be detected by the head-mounted display.

The operation unit 36 is operated by the user and supplies operation information in accordance with the user operation to a necessary block. Note that the operation unit 36 can be integrally provided with the display unit 34, for example, as a touch panel or the like. Alternatively, the operation unit 36 can be provided as a mouse, a controller, or the like separate from the display unit 34.

In response to the user operation (on the operation unit 36 or the like) on the 3D strobe image displayed on the display unit 34, the reproduction control unit 37 generates reproduction control information for control of reproduction of the moving image content of the free viewpoint data stored in the storage unit 32. In addition, in accordance with the reproduction control information, the reproduction control unit 37 controls the reproduction of the moving image content of the free viewpoint data stored in the storage unit 32. The control of the reproduction of the moving image content of the free viewpoint data includes control of the position (frame) at which the reproduction starts, control (setting) of a virtual viewpoint for generating a free viewpoint image by the free-viewpoint-image generation unit 33, and the like.

Examples of the reproduction control information include a timeline scenario and a shooting scenario. The timeline scenario is information indicating a reproduction procedure of reproducing the moving image content of the free viewpoint data. The shooting scenario is information indicating a virtual viewpoint for viewing of the free viewpoint data, that is, information indicating the shooting position and the shooting posture (furthermore, camera parameters such as a zoom ratio) of the virtual camera that shoots the free viewpoint data.

The storage unit 38 stores the file of the timeline scenario and the shooting scenario as the reproduction control information generated by the reproduction control unit 37.

Note that it is sufficient if the reproduction-and-editing device 13 has at least a function of communicating with the outside, a function of displaying an image, and a function of accepting a user operation. In FIG. 3, other functions such as the functions achieved by the free-viewpoint-image generation unit 33, the virtual-viewpoint setting unit 35, and the reproduction control unit 37 can be provided in, for example, a server on the cloud.

<Processing by Content Server 12>

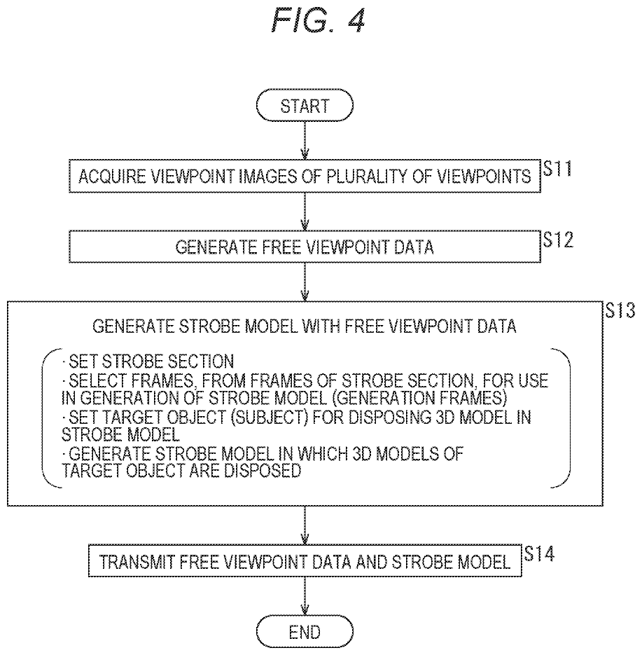

FIG. 4 is a flowchart explanatorily illustrating exemplary processing performed by the content server 12 of FIG. 2.

In step S11, the content server 12 acquires, on a frame basis, the viewpoint images of a plurality of viewpoints (and the corresponding depth images) shot by the shooting device 11. The content server 12 supplies the viewpoint images of the plurality of viewpoints to the free-viewpoint-data generation unit 21, and the processing proceeds from step S11 to step S12. Note that the viewpoint images of the plurality of viewpoints shot by the shooting device 11 can be transmitted from the reproduction-and-editing device 13 to the content server 12 through the reproduction-and-editing device 13.

In step S12, the free-viewpoint-data generation unit 21 generates free viewpoint data on a frame basis, with, for example, the viewpoint images of the plurality of viewpoints, and supplies the free viewpoint data to the strobe-model generation unit 22 and the storage unit 23. The storage unit 23 stores moving image content including the free viewpoint data on the frame basis (moving image content of the free viewpoint data) from the free-viewpoint-data generation unit 21. Thereafter, the processing proceeds from step S12 to step S13.

In step S13, the strobe-model generation unit 22 generates a strobe model, with the free viewpoint data from the free-viewpoint-data generation unit 21.

That is, the strobe-model generation unit 22 sets a strobe section including frames for generating a strobe model. For example, all sections of the moving image content of the free viewpoint data, a section from a scene change to the next scene change, a section specified by the reproduction-and-editing device 13 in response to a user operation, or the like are set as the strobe section.

The strobe-model generation unit 22 also sets an object shown in each viewpoint image as a target object for disposing the 3D model in the strobe model. For example, all the objects shown in the frames in the strobe section are each set as a target object, or an object specified by the reproduction-and-editing device 13 in response to a user operation or the like is set as a target object.

Furthermore, the strobe-model generation unit 22 selects, from the frames in the strobe section, a frame for use in generation of a strobe model (hereinafter, also referred to as a generation frame).

Here, if all the frames in the strobe section are used as generation frames to generate a strobe model, the 3D models of the same objects same in number as the frames in the strobe section are superimposed in the strobe model. Thus, the 3D strobe image is difficult to see in some cases.

Therefore, the strobe-model generation unit 22 can select some frames as generation frames from the frames in the strobe section and can generate a strobe model with (the 3D models of the objects shown in) the generation frames.

The strobe-model generation unit 22 can select a frame having a level of interference in 3D model not more than a threshold, from the frames in the strobe section, as a generation frame, for example. That is, the strobe-model generation unit 22 calculates the level of interference indicating the level of superimposition between 3D models with the 3D models of the target object shown in the frames in the strobe section disposed in a three-dimensional space. The level of interference is calculated, defined as 100% for the case where the 3D models of any two frames are completely superimposed in a three-dimensional space and 0% for the case where the 3D models of any two frames are not superimposed at all in a three-dimensional space, for example. Then, the strobe-model generation unit 22 selects, as generation frames, frames each having a level of interference not more than a predetermined threshold. As described above, frames each having a level of interference in 3D model not more than a threshold are selected as generation frames from frames in a strobe section, and a strobe model in which the 3D models of the target object shown in the generation frames are disposed is generated. As a result, it can be inhibited that the 3D strobe image is difficult to see due to superimposition of the 3D models in the strobe model.

Note that in addition to the above, in generation-frame selection, for example, the frames in a strobe section can be simply selected as generation frames for each predetermined number of frames. Alternatively, in generation-frame selection, all frames in a strobe section can be selected as generation frames.

The strobe-model generation unit 22 uses the free viewpoint data from the free-viewpoint-data generation unit 21, and generates a strobe model in which the 3D models of the target object shown in the plurality of generation frames selected from the frames in the strobe section are disposed on (the 3D model of) the background as the three-dimensional space at the time of shooting of the target object.

The strobe-model generation unit 22 supplies, to the storage unit 23, the strobe model of the moving image content of the free viewpoint data from the free-viewpoint-data generation unit 21, that is, the strobe model generated with the free viewpoint data from the free-viewpoint-data generation unit 21. The storage unit 23 stores the strobe model from the strobe-model generation unit 22, and the processing proceeds from step S13 to step S14.

In step S14, for example, in response to a request from the reproduction-and-editing device 13, the communication unit 24 transmits the moving image content of the free viewpoint data and the strobe model stored in the storage unit 23, to the reproduction-and-editing device 13, and then the processing ends.

<Processing of Reproduction-and-Editing Device 13>

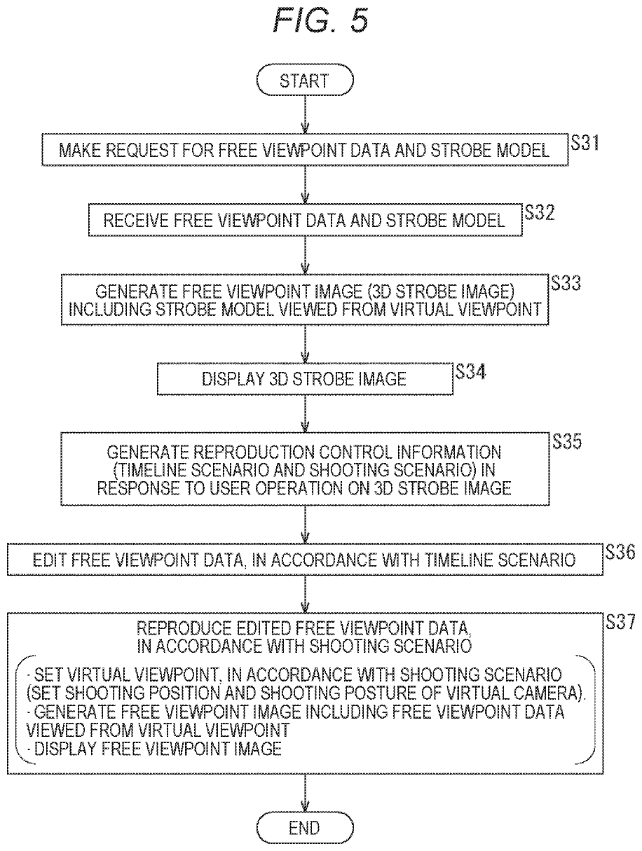

FIG. 5 is a flowchart explanatorily illustrating exemplary processing performed by the reproduction-and-editing device 13 of FIG. 3.

In step S31, for example, in response to a user operation, the communication unit 31 requests the content server 12 for the moving image content of the free viewpoint data and the strobe model, and the processing proceeds to step S32.

In step S32, the communication unit 31 remains on standby until the moving image content of the free viewpoint data and the strobe model are transmitted from the content server 12, and receives the moving image content of the free viewpoint data and the strobe model. The communication unit 31 supplies, from the content server 12, the moving image content of the free viewpoint data and the strobe model to the storage unit 32, the storage unit 32 stores the moving image content of the free viewpoint data and the strobe model, and the processing proceeds from step S32 to step S33.

In step S33, the free-viewpoint-image generation unit 33 renders and generates a free viewpoint image as a 3D strobe image including the strobe model stored in the storage unit 32 viewed from the virtual viewpoint supplied from the virtual-viewpoint setting unit 35. Then, the free-viewpoint-image generation unit 33 supplies the 3D strobe image to the display unit 34, and the processing proceeds from step S33 to step S34.

In step S34, the display unit 34 displays the 3D strobe image from the free-viewpoint-image generation unit 33, and the processing proceeds to step S35.

In step S35, in response to a user operation on the strobe model displayed on the display unit 34, the reproduction control unit 37 generates a timeline scenario and a shooting scenario as reproduction control information for control of reproduction of the moving image content of the free viewpoint data stored in the storage unit 32. The reproduction control unit 37 supplies the reproduction control information to the storage unit 38, the storage unit 38 stores the reproduction control information, and the processing proceeds from step S35 to step S36.

In step S36, for example, the reproduction control unit 37 remains on standby until the user performs a confirmation operation for confirming the reproduction control information stored in the storage unit 38, edits the moving image content of the free viewpoint data stored in the storage unit 32, in accordance with the timeline scenario as the reproduction control information, and the processing proceeds to step S37.

In step S37, for example, the reproduction control unit 37 remains on standby until the user performs a reproduction operation for requesting reproduction of the edited moving image content of the free viewpoint data, controls the reproduction of the edited moving image content of the free viewpoint data stored in the storage unit 32, in accordance with the shooting scenario as the reproduction control information stored in the storage unit 38, and the processing ends.

In the control of the reproduction of the moving image content of the free viewpoint data according to the shooting scenario, the reproduction control unit 37 sets, in accordance with the shooting scenario, the virtual viewpoint, that is, the shooting position and the shooting posture of a virtual camera that shoots the free viewpoint data, and then supplies the virtual viewpoint to the free-viewpoint-image generation unit 33. Furthermore, the reproduction control unit 37 performs control such that the free-viewpoint-image generation unit 33 renders and generates a free viewpoint image including the edited free viewpoint data stored in the storage unit 32 viewed from the virtual viewpoint set in accordance with the shooting scenario. Then, the reproduction control unit 37 controls the free-viewpoint-image generation unit 33 such that the free viewpoint image is supplied from the free-viewpoint-image generation unit 33 to the display unit 34 to cause the display unit 34 to display the free viewpoint image. Note that here, the moving image content of the free viewpoint data is edited in accordance with the timeline scenario as the reproduction control information; however, it is not essential to edit the moving image content of the free viewpoint data. For example, if a designated section is simply repeat-reproduced, it is sufficient to reproduce between the start frame and the end frame of the designated section without editing the moving image content of the free viewpoint data.

<Generation of 3D Strobe Image>

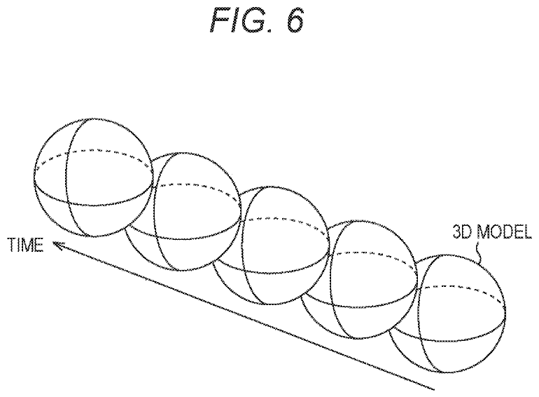

FIG. 6 illustrates an exemplary unnatural 3D strobe image.

FIG. 6 illustrates an exemplary 3D strobe image generated from a strobe model generated with, as generation frames, five of the frames of a viewpoint image acquired by shooting a ball as an object rolling from the near side to the far side.

In FIG. 6, the 3D models of the ball shown in the generation frames that are the five frames are disposed (rendered) such that the 3D model behind in time between each adjacent 3D model is prioritized. Thus, the 3D models (of the ball) are disposed such that each 3D model behind in time hides the corresponding 3D model ahead in time on the near side even though each 3D model behind in time is located on the far side. As a result, the 3D strobe image in FIG. 6 is an unnatural image.

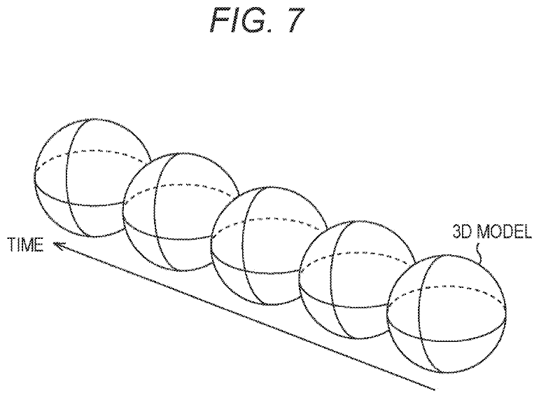

FIG. 7 illustrates an exemplary natural 3D strobe image.

FIG. 7 illustrates an exemplary 3D strobe image generated from a strobe model generated with, as generation frames, five of the frames of a viewpoint image acquired by shooting a ball as an object rolling from the near side to the far side.

In FIG. 7, the 3D models of the ball shown in the generation frames that are the five frames are disposed such that the 3D model on the near side between each adjacent 3D model is prioritized. Thus, the 3D models on the near side are disposed such that each 3D model on the near side hides the corresponding 3D model on the far side, that is, such that each 3D model on the near side is shown preferentially. As a result, the free viewpoint image is a natural image.

The free-viewpoint-image generation unit 33 uses the depth of the 3D model of each object disposed on the strobe model to generate such a 3D strobe image (obtained by shooting with a virtual camera), as described above, in which each 3D model of the object on the near side is shown preferentially.

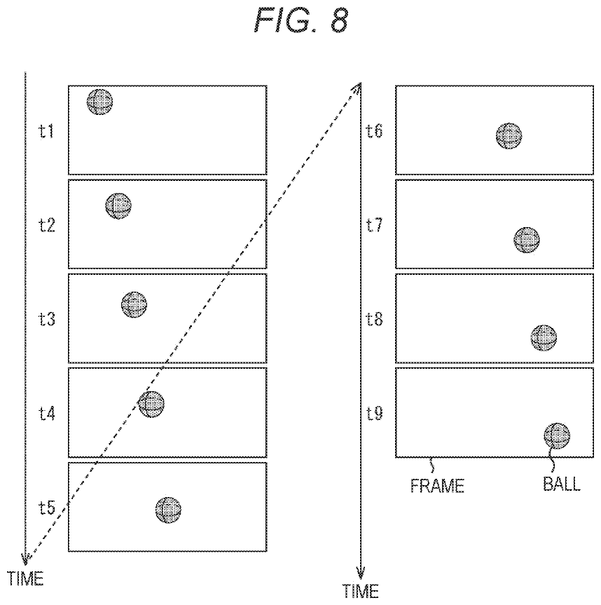

FIG. 8 illustrates exemplary frames of a viewpoint image in a strobe section.

In FIG. 8, nine frames at times t1 to t9 are frames of the viewpoint image in the strobe section. The frames at times t1 to t9 each show a ball as an object rolling from left to right. In FIG. 8, in order to avoid complicating the figure, the frames of the viewpoint image of a certain viewpoint are illustrated.

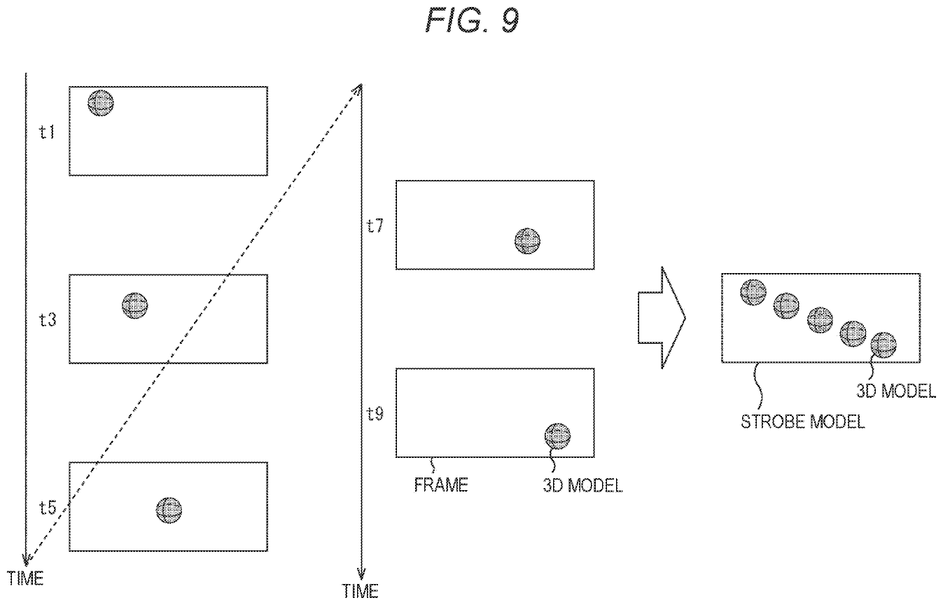

FIG. 9 illustrates exemplary strobe model generation with the frames at times t1 to t9 as a strobe section.

In FIG. 9, among the frames at times t1 to t9 as the strobe section, the frames at times t1, t3, t5, t7, and t9 are selected as generation frames, and the 3D models of the ball as an object shown in the frames at times t1, t3, t5, t7, and t9 as the generation frames of the viewpoint image of a plurality of viewpoints are generated. Then, a strobe model is generated in which the 3D models of the ball shown in the frames at times t1, t3, t5, t7, and t9 as the generation frames are disposed.

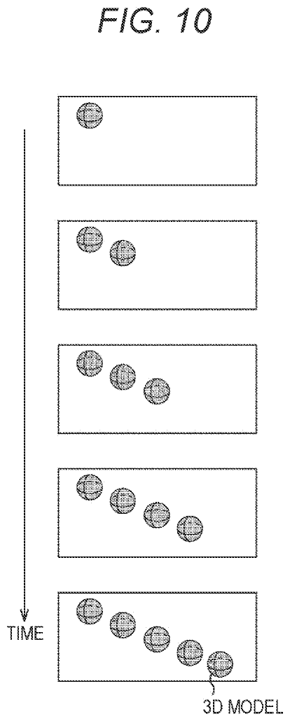

FIG. 10 illustrates an exemplary display of a 3D strobe image generated by shooting the strobe model with a virtual camera.

As a 3D strobe image, a frame showing the 3D models of the ball as the object shown in the frames at times t1, t3, t5, t7, and t9 can be generated and displayed. In addition, as the 3D strobe image, from the strobe model of FIG. 9, a frame showing the 3D model of the ball as the object shown in the frame at time t1, and a frame showing the 3D models of the ball as the object shown in the frames at times t1 and t3, a frame showing the 3D models of the ball as the object shown in the frames at times t1, t3, and t5, a frame showing the 3D models of the ball as the object shown in the frames at times t1, t3, t5, and t7, and a frame showing the 3D models of the ball as the object shown in the frames at times t1, t3, t5, t7, and t9 can be generated and displayed sequentially.

In the 3D strobe image of FIG. 10, the shooting position of the virtual camera that shoots the strobe model is not changed. The shooting position of the virtual camera, however, can be changed in accordance with the camera work. For example, the strobe model in which the 3D models of the ball as the object shown in the frames at times t1, t3, t5, t7, and t9 are disposed can be shot with the virtual camera while changing the shooting position. In response to the change of the shooting position, the viewpoint for viewing the strobe model is changed, and a 3D strobe image with the camera angle changed is displayed.

<Search for Predetermined Scene for Free Viewpoint Data>

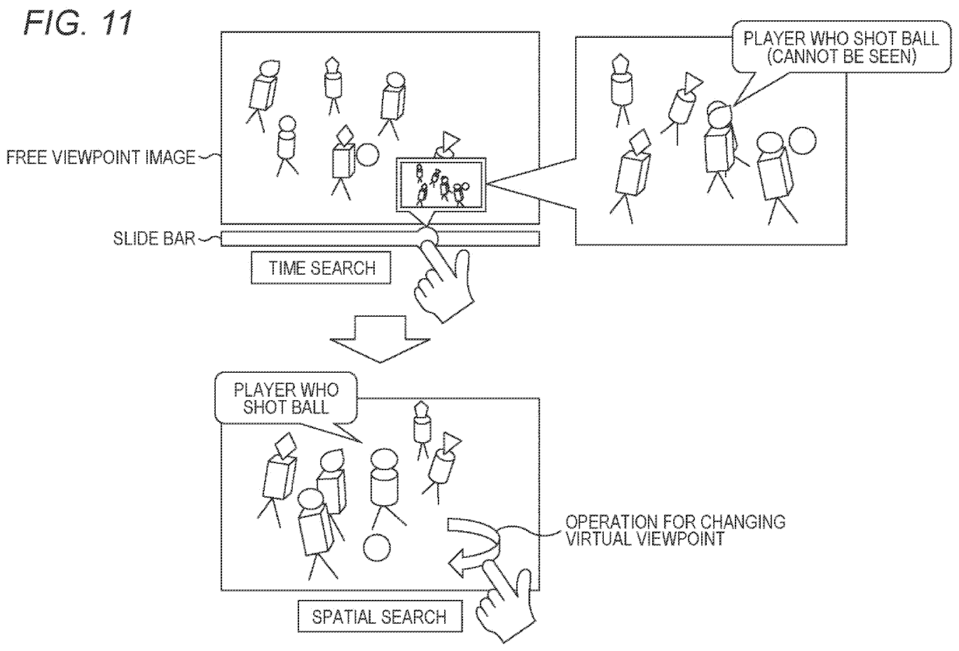

FIG. 11 explanatorily illustrates an exemplary user operation in search for a predetermined scene (frame) for free viewpoint data.

In reproduction and editing of an image (moving image), for example, it is required to efficiently search for the reproduction start position, the reproduction end position, and a specific scene such as a scene to be edited.

In a case where the target of reproduction and editing is a 2D image (moving image), search for a scene is only performed in the direction of time (chronological direction). Here, such search for a scene performed in the direction of time is also referred to as a time search.

On the other hand, in a case where the target of reproduction and editing is free viewpoint data (moving image), the free viewpoint data enables free setting of a virtual viewpoint for viewing of the free viewpoint data. Thus, even an object such as a person or object present in a certain frame (time) is not always shown in the free viewpoint image including the free viewpoint data viewed from the virtual viewpoint.

For example, in a case where the moving image content of the free viewpoint data is the moving image content of a soccer game, in a time search for a scene at the moment of shooting the ball by the player who shot the ball, the object as the player who shot the ball, at the moment of shooting the ball, is hidden behind another player as another object and cannot be seen in the free viewpoint image depending on the position of the virtual viewpoint, as illustrated in FIG. 11. In this case, as illustrated in FIG. 11, the user needs to perform an operation of changing the virtual viewpoint and, in the free viewpoint image, search for a position of the virtual viewpoint such that the player who shot the ball at the moment of shooting the ball is viewable. Here, the search for the position of the virtual viewpoint is also referred to as a spatial search.

When the free viewpoint image after the spatial search is not a desired scene, that is, for example, if the scene has a slight time lag to the moment of shooting the ball, the user needs to repeat a time search and a spatial search.

As described above, in search for a desired scene showing a desired object for free viewpoint data, the user needs to repeat (operation of) a time search and a spatial search until the desired scene showing the desired object is found.

Thus, in a case where the target of reproduction and editing is free viewpoint data, displaying of a free viewpoint image including the free viewpoint data viewed from a virtual viewpoint and searching for a desired scene while looking at the free viewpoint image by the user take time in effort for the search work, so that the burden on the user is larger.

In addition, search work needs display of a graphic user interface (GUI) such as a slide bar for performing a time search and a GUI for performing a spatial search. Furthermore, in some cases, in order to search a scene at the moment, a plurality of frames needs to be displayed side by side.

Thus, in order to search for a desired scene, GUIs for performing a time search or a spatial search and a wide space for displaying a plurality of frames of a free viewpoint image are required.

Therefore, in the present technology, a 3D strobe image is adopted as a user interface (UI) for work such as search for a desired scene. This adoption achieves reduction of the burden of work by the user required for searching for a desired scene and required for reproducing and editing the moving image content of free viewpoint data, and achieves reduction of a space required for reproducing and editing the moving image content of the free viewpoint data.

<Exemplary Moving Image Content of Free Viewpoint Data>

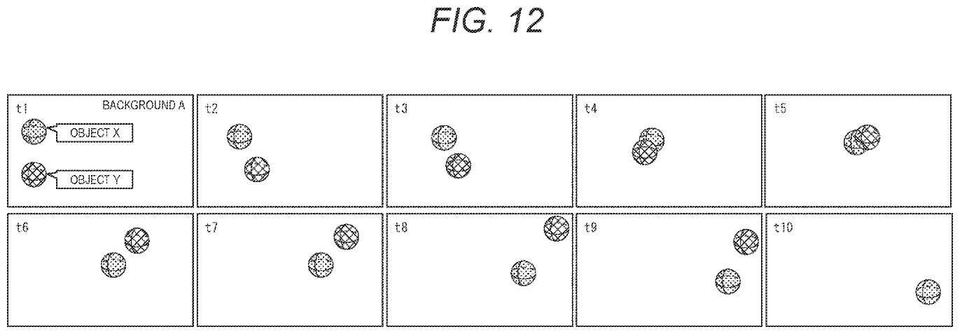

FIG. 12 explanatorily illustrates exemplary moving image content of free viewpoint data.

FIG. 12 illustrates an exemplary free viewpoint image including free viewpoint data viewed from a predetermined virtual viewpoint, that is (the rendered image of) a free viewpoint image acquired by shooting free viewpoint data with a virtual camera.

The moving image content of the free viewpoint data of FIG. 12 includes, as time information, for example, 10 frames with time codes t1 to t10, and includes data of balls, as two objects X and Y, moving from left to right. The moving image content of the free viewpoint data of FIG. 12 further includes data of only one type of background A as background data.

Hereinafter, processing by the content server 12 and the reproduction-and-editing device 13 for at least the moving image content of the free viewpoint data of FIG. 12 will be described.

Note that a frame with a time code t#i is also referred to as a frame t#i.

<Exemplary Strobe Model>

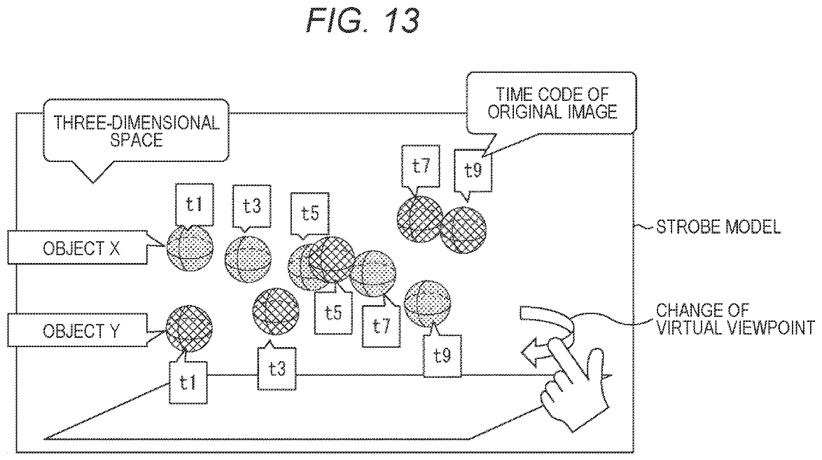

FIG. 13 illustrates an exemplary strobe model generated with the moving image content of the free viewpoint data of FIG. 12.

In FIG. 13, the section including all the 10 frames of the moving image content of the free viewpoint data of FIG. 12 is set as a strobe section, and the frames t1, t3, t5, t7, and t9 that are the odd-numbered frames in the strobe section are selected as generation frames. Then, all of the two objects X and Y shown in the generation frames are set as target objects, and a strobe model in which the 3D models of the target objects X and Y of the frames t1, t3, t5, t7, and t9 are disposed in the three-dimensional space as the background is generated.

The free viewpoint image including the strobe model viewed from the virtual viewpoint is a 3D strobe image, and the virtual viewpoint for viewing of the strobe model can be changed in response to a user operation.

In the strobe model, the 3D models of the objects X and Y of the generation frames (time codes t1, t3, t5, t7, and t9) each have information such as position information within the three-dimensional space possessed by a typical 3D model, as well as a time code t#i as time information given in the original moving image content of the free viewpoint data.

Note that in FIG. 13, each balloon with the time code t#i described and respective balloons with the objects X and Y described are balloons to facilitate understanding of the figure, and thus are not constituent elements of the strobe model. The same applies to the following figures for the balloons.

<First Exemplary User Operation on 3D Strobe Image>

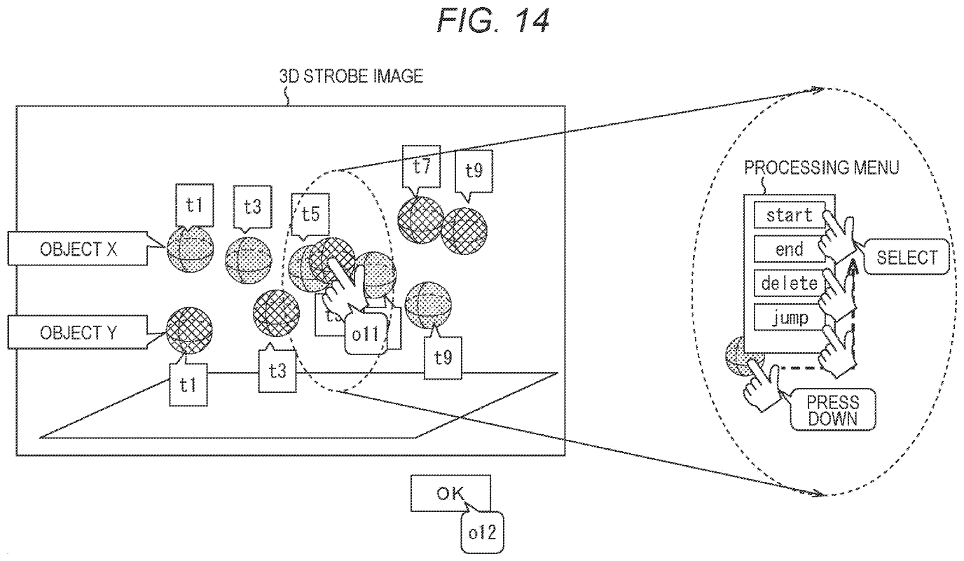

FIG. 14 explanatorily illustrates a first exemplary user operation on, as a UI, the 3D strobe image including the strobe model viewed from the virtual viewpoint of FIG. 13.

The user uses, as the UI, the 3D strobe image displayed on the display unit 34, and performs various operations on the 3D strobe image as the UI. Thus, the user can perform work for reproduction and editing of the moving image content of the free viewpoint data (hereinafter, also referred to as reproduction-and-editing work).

For example, the 3D strobe image shows the objects shown in the plurality of generation frames, and thus the user can easily search for a desired scene (desired object) by looking at the 3D strobe image. Furthermore, the user selects the desired object shown in the 3D strobe image (including the frame showing the desired object of the free viewpoint data), and assigns desired processing to (the frame showing) the desired object. Thus, the user can easily perform reproduction-and-editing work.

FIG. 14 illustrates reproduction-and-editing work in which when the frame showing the desired object (scene) is, for example, the frame t5 showing the object X, the moving image content of the free viewpoint data is reproduced with the frame t5 set as the reproduction start position (reproduction start frame).

If necessary, the user changes the virtual viewpoint for viewing of the strobe model such that the object X shown in the frame t5 is shown in the 3D strobe image. Then, in the 3D strobe image, the user presses and selects the object X/Y shown in the frame t5 as the desired object, for example (operation oil). Here, the object X/Y means the object X or Y. The object X/Y shown in the frame t#i is appropriately described below as the object X/Y-t#i.

Note that the object X/Y shown in the 3D strobe image can be selected by double-clicking or performing another operation, in addition to the pressing of the object X/Y.

In response to the pressing of the object X/Y, the reproduction control unit 37 causes, through the free-viewpoint-image generation unit 33, the display unit 34 to display the processing menu indicating processing for assignation to the object selected by the pressing or the frame showing the object and the OK button. The processing menu of FIG. 14 has buttons indicating one-to-one pieces of processing start, end, delete, and jump. The processing start is processing for starting frame-reproduction, and the processing end is processing for ending the frame-reproduction. The processing delete is processing for frame-deletion, and the processing jump is processing for jumping frame-reproduction.

Selecting a button in the processing menu allows the user to assign the processing corresponding to the button to the frame showing the object X/Y selected by the pressing.

For example, when the user selects the button indicating the processing start in the processing menu and then presses the OK button (operation o12), the reproduction control unit 37 generates a timeline scenario (TS1) indicating assignation of the processing start to the frame t5.

<play>

t5: start
. . . (TS1)

The timeline scenario (TS1) indicates that reproduction starts with the frame t5 for the reproduction (play) of the moving image content of the free viewpoint data.

In the reproduction of the moving image content of the free viewpoint data according to the timeline scenario (TS1), the reproduction control unit 37 starts the reproduction with the frame t5. Alternatively, in accordance with the timeline scenario (TS1), the reproduction control unit 37 edits the moving image content of the free viewpoint data of FIG. 12 having the frames t1 to t10 into the moving image content of the free viewpoint data with the frame t5 set as the head frame and the frame t10 set as the last frame, and reproduces the edited moving image content of free viewpoint data.

As described above, the reproduction control unit 37 can generate a timeline scenario as reproduction control information for start of reproduction with the frame showing an object selected in a 3D strobe image, and can control reproduction of the free viewpoint data in accordance with the reproduction control information. Note that the 3D strobe image can be prepared exclusively for the start of reproduction, such as chapter reproduction included in a DVD menu. In this case, in the 3D strobe image, reproduction can start with the frame t#i simply by selecting the object at the specific time t#i.

<Second Exemplary User Operation on 3D Strobe Image>

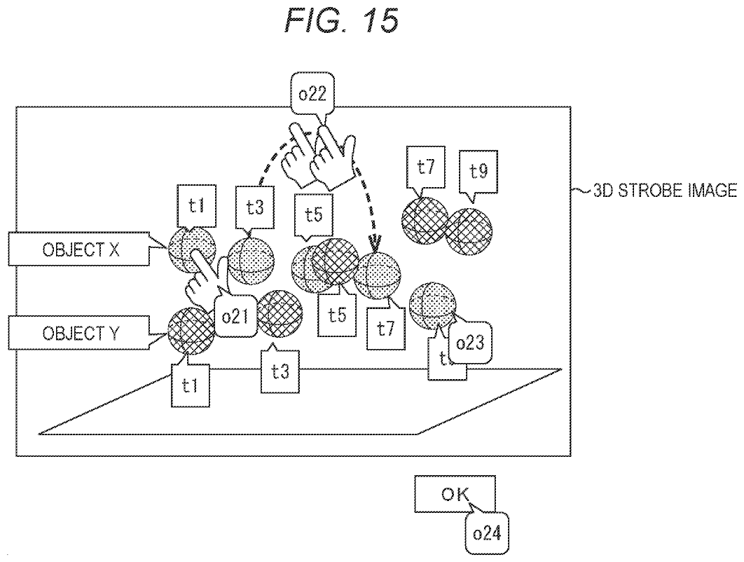

FIG. 15 explanatorily illustrates a second exemplary user operation on, as the UI, the 3D strobe image including the strobe model viewed from the virtual viewpoint of FIG. 13.

FIG. 15 illustrates reproduction-and-editing work in which, for example, with the frame t1 showing the object X set as the reproduction start position, the moving image content of the free viewpoint data is reproduced to the frame t3, and then the reproduction jumps to the frame t7 and is performed to the frame t9.

If necessary, the user changes the virtual viewpoint for viewing of the strobe model such that each object X shown in the frames t1, t3, t5, t7, and t9 is shown in the 3D strobe image. Then, in the 3D strobe image, the user presses and selects the object X/Y-t1, for example (operation o21). In response to the pressing of the object X/Y-t1, the processing menu and the OK button are displayed as described in FIG. 14, and then the user selects the button indicating the processing start in the processing menu to assign the processing start to the frame t1.

Thereafter, in the 3D strobe image, the user presses and selects the object X/Y-t3, for example (operation o22). The processing menu and the OK button are displayed in response to the pressing of the object X/Y-t3, and then the user selects the button indicating the processing jump in the processing menu (FIG. 14) to assign the processing jump to the frame t3. After the selecting the button indicating the processing jump, the user drags the object X/Y-t3 to the object X/Y-t7 while tracing the object X/Y-t3 to the object X/Y-t7, and selects the object X/Y-t7. As a result, the processing jump for jumping the reproduction to the frame t7 is assigned to the frame t3.

Thereafter, in the 3D strobe image, the user presses and selects the object X/Y-t9, for example (operation o23). The processing menu and the OK button are displayed in response to the pressing of the object X/Y-t9, and then the user selects the button indicating the processing end in the processing menu (FIG. 14) to assign the processing end to the frame t9.

Then, the user presses the OK button (operation o24). In this case, the reproduction control unit 37 generates a timeline scenario (TS2) indicating that each piece of processing is assigned to the corresponding frame as follows.

<play>

t1: start

t3: jump-t7

t9: end
. . . (TS2)

The timeline scenario (TS2) indicates that the reproduction starts with the frame t1, jumps to the frame t7 after reproducing the frame t3, and ends reproducing at the frame t9, for the reproduction (play) of the moving image content of the free viewpoint data.

In reproduction of the moving image content of the free viewpoint data according to the timeline scenario (TS2), the reproduction control unit 37 starts the reproduction with the frame t1, jumps the reproduction (position) to the frame t7 after reproducing the frame t3, and then continues the reproduction. Then, the reproduction control unit 37 ends the reproduction at the frame t9. Alternatively, in accordance with the timeline scenario (TS2), the reproduction control unit 37 edits the moving image content of the free viewpoint data of FIG. 12 into the moving image content of the free viewpoint data including the frames t1 to t3 and the frames t7 to t9, and reproduces the edited moving image content of the free viewpoint data.

As described above, the reproduction control unit 37 can generate a timeline scenario as reproduction control information for start of reproduction from the frame showing an object selected in a 3D strobe image and for end of the reproduction at the frame showing another object selected in the 3D strobe image.

In addition, the reproduction control unit 37 can generate a timeline scenario as reproduction control information for jump of reproduction from the frame showing an object selected in a 3D strobe image to the frame showing another object selected in the 3D strobe image.

Furthermore, the reproduction control unit 37 can control the reproduction of the free viewpoint data in accordance with the reproduction control information as described above.

<Third Exemplary User Operation on 3D Strobe Image>

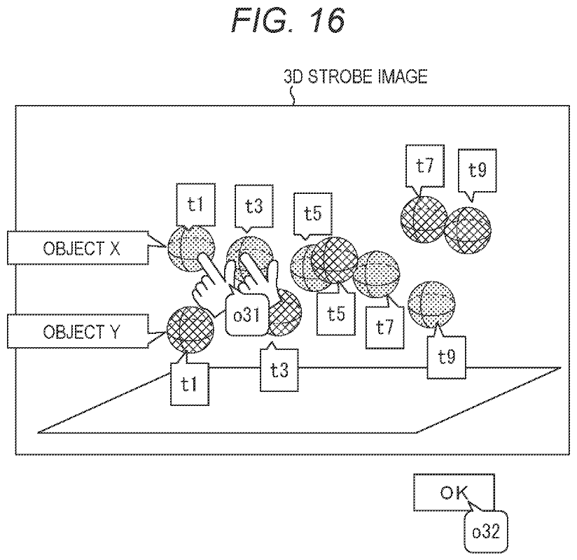

FIG. 16 explanatorily illustrates a third exemplary user operation on, as the UI, the 3D strobe image including the strobe model viewed from the virtual viewpoint of FIG. 13.

FIG. 16 illustrates reproduction-and-editing work in trimming of the frame t5 to the frame t10 each showing the object X, for example.

If necessary, the user changes the virtual viewpoint for viewing of the strobe model such that each object X shown in the frames t1, t3, t5, t7, and t9 is shown in the 3D strobe image. Then, in the 3D strobe image, the user presses the object X/Y-t1 and further presses the object X/Y-t3, and selects the object X/Y-t1 and the object X/Y-t3, for example (operation o31). In response to the pressing of the object X/Y-t1 and the object X/Y-t3, the processing menu and the OK button are displayed as described in FIG. 14, and then the user selects the button indicating the processing delete in the processing menu displayed after the pressing of the object X/Y-t3 to assign the processing delete to the frames t1 to t3.

Then, the user presses the OK button (operation o32). In this case, the reproduction control unit 37 generates a timeline scenario (TS3) indicating that each piece of processing is assigned to the corresponding frame as follows.

<edit>

t1: delete_start

t4: delete_end
. . . (TS3)

The timeline scenario (TS3) indicates that the frame t1 is set as the start point and the frame t4 is set as the end point, and frame deletion is performed (and the remaining frames are reproduced), for the editing (edit) of the moving image content of the free viewpoint data.

Here, in the timeline scenario (TS3), among the objects shown in the 3D strobe image, the frame t4 previous to the frame t5 including the object X/Y-t5 next to the object X/Y-t3 pressed by the user for the second time is set as the end point for the frame deletion. However, as the frame set as the end point for the frame deletion, the frame including the object pressed by the user for the second time among the objects shown in the 3D strobe image can be adopted. In this case, in response to the pressing of the object X/Y-t1 and the further pressing of the object X/Y-t3 in the 3D strobe image by the user, a timeline scenario indicating that frame deletion is performed with the frame t1 set as the start point and the frame t3 set as the end point is generated, for example.

In reproduction of the moving image content of the free viewpoint data according to the timeline scenario (TS3), the reproduction control unit 37 reproduces only the frames t5 to t10 that are not the targets of the deletion. Alternatively, the reproduction control unit 37 edits the moving image content of the free viewpoint data of FIG. 12 in accordance with the timeline scenario (TS3), and reproduces the edited moving image content of the free viewpoint data.

Even in the reproduction of the moving image content of the free viewpoint data according to the timeline scenario (TS3), the reproduction control unit 37 edits the moving image content of the free viewpoint data in accordance with the timeline scenario (TS3), and even in the reproduction of the edited moving image content of the free viewpoint data, the reproduction control unit 37 reproduces only the frames t5 to t10. Thus, reproducing the moving image content of the free viewpoint data in accordance with the timeline scenario (TS3), and editing the moving image content of the free viewpoint data in accordance with the timeline scenario (TS3) and then reproducing the edited moving image content of the free viewpoint data can be considered equivalent (equal).

As described above, the reproduction control unit 37 can generate a timeline scenario as reproduction control information for deletion of the frame showing an object selected in a 3D strobe image to the frame showing another object selected in the 3D strobe image. Furthermore, reproduction of the free viewpoint data can be controlled in accordance with the reproduction control information.

<Fourth Exemplary User Operation on 3D Strobe Image>

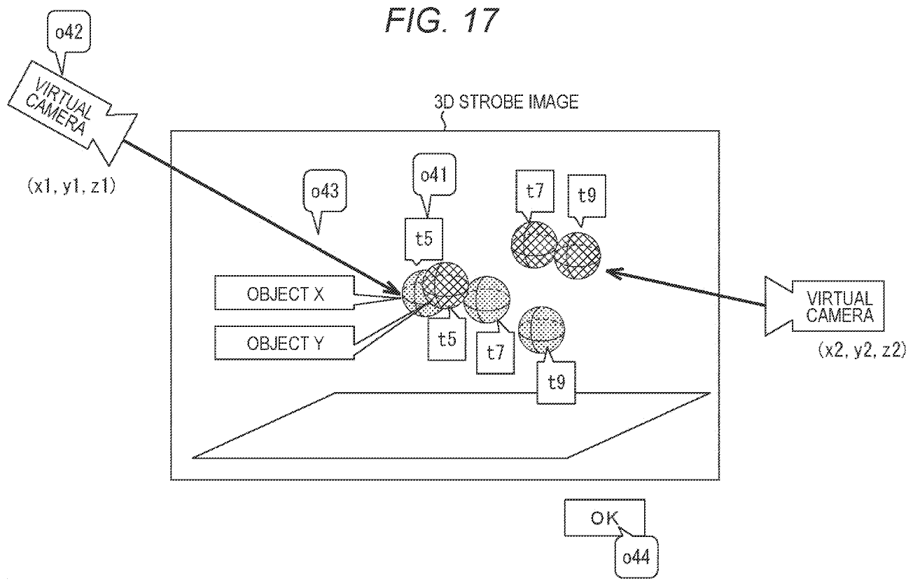

FIG. 17 explanatorily illustrates a fourth exemplary user operation on, as the UI, the 3D strobe image including the strobe model viewed from the virtual viewpoint of FIG. 13.

FIG. 17 illustrates reproduction-and-editing work in setting of the shooting position and shooting posture (virtual viewpoint) of a virtual camera.

In FIG. 17, the 3D strobe image is a free viewpoint image in which, in accordance with the timeline scenario (TS1), the moving image content of the free viewpoint data of the FIG. 12 having the frames t1 to t10 is edited into the moving image content of the free viewpoint data with the frame t5 set as the head frame and the frame t10 set as the last frame, and including the strobe model generated with, as generation frames, the frames t5, t7, and t9 of the edited moving image content of the free viewpoint data viewed from the virtual viewpoint.

As described above, the reproduction-and-editing device 13 displays, on the display unit 34, the 3D strobe image, as the UI, corresponding to the strobe model generated with the edited moving image content of the free viewpoint data edited in accordance with a timeline scenario.

The reproduction-and-editing device 13 can generate the strobe model with the edited moving image content of the free viewpoint data edited in accordance with the timeline scenario. Alternatively, the reproduction-and-editing device 13 can request the content server 12 to generate the strobe model.

If necessary, the user changes the virtual viewpoint for viewing of the strobe model such that a required object is shown in the 3D strobe image. Then, the user selects the object shown in the frame (time) for which the state (shooting position and shooting posture) of the virtual camera is to be set in the 3D strobe image (operation o41). Furthermore, in the 3D strobe image, the user inputs the position and posture of the virtual camera that shoots the free viewpoint data of the frame following the frame showing the previously selected object, as the shooting position and the shooting posture (operations o42 and o43). The position of the virtual camera can be input by, for example, the user specifying the position on the 3D strobe image. The posture of the virtual camera can be input by, for example, the user specifying an object on the 3D strobe image. In this case, the posture of the virtual camera in the direction of shooting from the position of the virtual camera toward the object specified by the user is the shooting posture.

In response to the input of the position and posture of the virtual camera, the OK button is displayed. When the user presses the OK button (operation o44), the reproduction control unit 37 generates a shooting scenario in which a set of the time code as the time information of the frame showing the object selected by the user in the 3D strobe image and the shooting position and the shooting posture input by the user after the selecting the object is registered.

Object selection and input of the shooting position and the shooting posture can be repeated. In a case where object selection and input of the shooting position and shooting posture are repeated and then the OK button is pressed, by the number of times of repetition, generated are shooting scenarios in which the time code of the frame showing the object selected by the user and the shooting position and the shooting posture input by the user are registered.

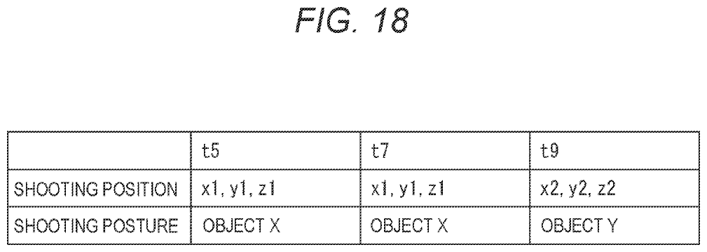

FIG. 18 is a table indicating an exemplary shooting scenario.

As described with reference to FIG. 17, in a shooting scenario, registered is a set of the time code of the frame showing the object selected by the user in the 3D strobe image and the shooting position and the shooting posture input by the user after the selecting the object.

In the shooting scenario of FIG. 18, registered are a set of the time code t5, the position (x1, y1, z1) representing the shooting position, and the object X representing the direction of shooting; a set of the time code t7, the position (x1, y1, z1) representing the shooting position, and the object X representing the direction of shooting; and a set of the time code t9, the position (x2, y2, z12 representing the shooting position, and the object Y representing the direction of shooting.

The set of the time code t5, the position (x1, y1, z1) representing the shooting position, and the object X representing the direction of shooting indicates that, for the time code t5 and later, the free viewpoint data is shot with the virtual camera with the position (x1, y1, z1) set as the shooting position and the posture (direction) from the shooting position (x1, y1, z1) toward the object X set as the shooting posture.

The set of the time code t7, the position (x1, y1, z1) representing the shooting position, and the object X representing the direction of shooting indicates that, for the time code t7 and later, the free viewpoint data is shot with the virtual camera with the position (x1, y1, z1) set as the shooting position and the posture from the position (x1, y1, z1) toward the object X set as the shooting posture.

The set of the time code t9, the position (x2, y2, z2) representing the shooting position, and the object Y representing the direction of shooting indicates that, for the time code t9 and later, the free viewpoint data is shot with the virtual camera with the position (x2, y2, z2) set as the shooting position and the posture from the shooting position (x2, y2, z2) toward the object Y set as the shooting posture.

In control of reproduction of the moving image content of the free viewpoint data according to the shooting scenarios of FIG. 18, the free-viewpoint-image generation unit 33 (FIG. 3) generates, for the frames t5 to t8, a free viewpoint image acquired by shooting the free viewpoint data with the virtual camera with the shooting posture from the shooting position (x1, y1, z1) toward the object X. The free-viewpoint-image generation unit 33 further generates, for the frames t9 and t10, a free viewpoint image acquired by shooting the free viewpoint data with the virtual camera with the shooting posture from the shooting position (x2, y2, z2) toward the object Y.

<Processing Jump>

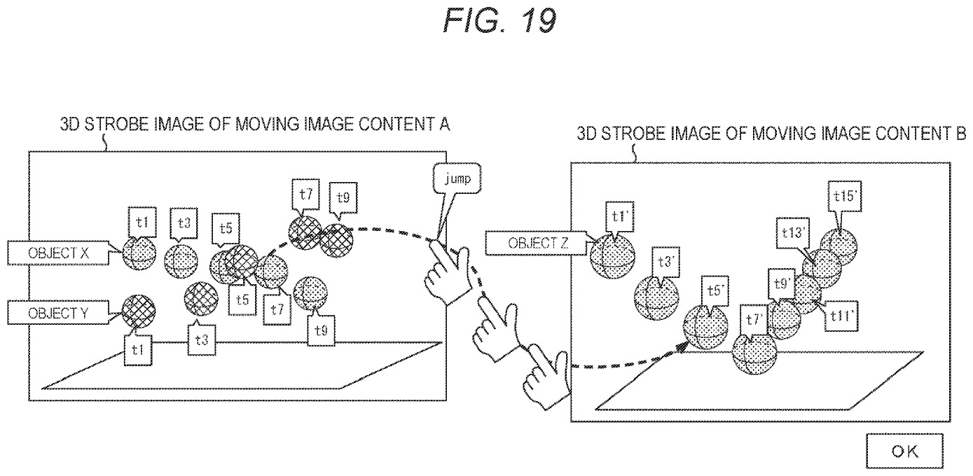

FIG. 19 explanatorily illustrates exemplary processing jump.

FIG. 19 illustrates exemplary processing jump different from that of FIG. 15

With reference to FIG. 15, there has been described the reproduction-and-editing work in the assignation of the processing jump to the frame t3 of certain free viewpoint data to jump the reproduction from the frame t3 to the frame t7 of the free viewpoint data of the same moving image content. Reproduction, however, can jump from the frame of the free viewpoint data of certain moving image content A to the frame of the free viewpoint data of moving image content B different from the moving image content A.

In this case, the user operates the operation unit 36 to cause the display unit 34 to display the 3D strobe image of the moving image content A (3D strobe image generated from the free viewpoint data of the moving image content A) and the 3D strobe image of the moving image content B.

The user presses and selects the object X/Y-t5 in the 3D strobe image of the moving image content A, for example. In response to the pressing of the object X/Y-t5, the processing menu and the OK button are displayed as described in FIG. 14, and then the user selects the button indicating the processing jump in the processing menu to assign the processing jump to the frame t5 of the free viewpoint data of the moving image content A. After the selecting the button indicating the processing jump, the user drags the object X/Y-t5 to the object Z-t5′ shown in the 3D strobe image of the moving image content B while tracing the object X/Y-t5 to the object Z-t5′, and selects the object Z-t5′. As a result, the processing jump for jumping reproduction to the frame t5′ of the free viewpoint data of the moving image content B is assigned to the frame t5 of the free viewpoint data of the moving image content A. Thereafter, in response to pressing of the OK button, generated is a timeline scenario in which jumping from the frame t5 of the free viewpoint data of the moving image content A to the frame t5′ of the free viewpoint data of the moving image content B is registered.

In reproduction according to such a timeline scenario, the free viewpoint data of the moving image content A is reproduced to the frame t3, and then the reproduction (position) jumps to the frame t5′ of the free viewpoint data of the moving image content B.

As described above, the reproduction control unit 37 can generate a timeline scenario as reproduction control information for jump of reproduction from the frame showing an object selected in the 3D strobe image of predetermined moving image content to the frame showing another object selected in the 3D strobe image of another piece of moving image content. Furthermore, the reproduction of the free viewpoint data (including combining a plurality of pieces of moving image contents) can be controlled in accordance with the reproduction control information.

Hereinafter, there will be described other pieces of reproduction-and-editing work, for example, reproduction-and-editing work for assignation of processing other than the pieces of processing start, end, delete, and jump.

<Other Pieces of Reproduction-and-Editing Work>

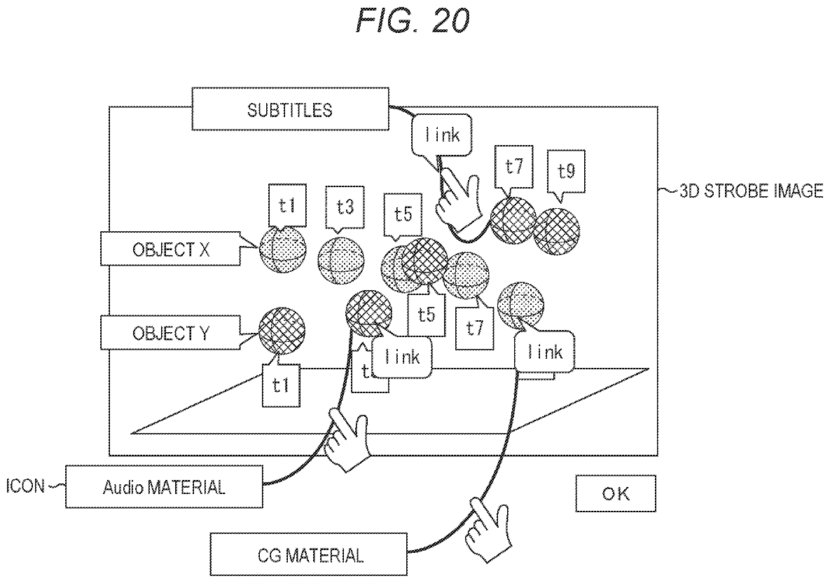

FIG. 20 explanatorily illustrates exemplary reproduction-and-editing work for assignation of processing link.

In addition to the pieces of processing start, end, delete, and jump described with reference to FIG. 14, the processing link can be adopted as processing assigned to (a frame showing) an object, for example. The processing link is processing of linking various types of data with (a frame showing) an object.

Audio materials, computer graphic (CG) materials, subtitles, or the like can be adopted as data for link with the object. The processing link can be assigned to the object, for example, by dragging an icon indicating data for link with the object, onto the object to which the processing link is assigned, in the 3D strobe image. For example, in response to the dragging of the icon indicating the data for link with the object onto the object to which the processing link is assigned, the OK button is displayed. In response to pressing of the OK button, generated is a timeline scenario in which information regarding a set of the object with the processing link assigned in accordance with the drag performed so far and the data for link with the object is registered.

In reproduction according to such a timeline scenario, the data in link with the object is also reproduced at reproduction of (the frame showing) the object with the processing link assigned.

As described above, the reproduction control unit 37 can generate a timeline scenario as reproduction control information for link of an object selected in a 3D strobe image with predetermined data. Furthermore, reproduction of the free viewpoint data can be controlled in accordance with the reproduction control information.

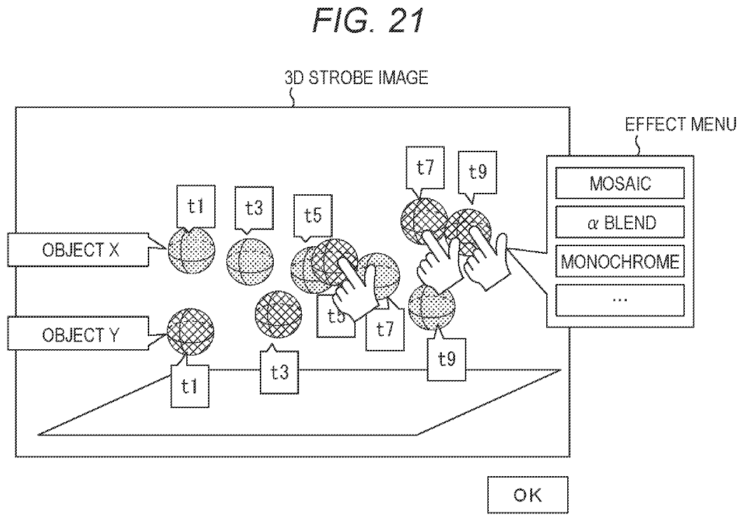

FIG. 21 explanatorily illustrates exemplary reproduction-and-editing work for assignation of effect processing.

To an object, effect processing to be applied to the 3D model of the object can be assigned. For example, if the operation unit 36 is operated so as to apply the effect processing to (the 3D model of) the object with the 3D strobe image displayed on the display unit 34, the reproduction control unit 37 causes the display unit 34 to display the effect menu and the OK button through the free-viewpoint-image generation unit 33. The effect menu has buttons indicating effect processing such as mosaic, a blend, and monochrome. Mosaic is effect processing of mosaicing an object, and a blend is effect processing of a blending an object. Monochrome is effect processing of making the texture of an object black and white.

The user presses and selects a desired object in the 3D strobe image and further selects, in the effect menu, a button indicating desired effect processing for applying to the desired effect, for example. Thereafter, in response to pressing of the OK button by the user, generated is a timeline scenario in which the application of the desired effect processing to the desired object is registered.

In reproduction according to such a timeline scenario, the desired effect processing is applied to the free viewpoint data (3D model) of the desired object, and a free viewpoint image is generated with the free viewpoint data of the desired object after the application of the desired effect processing.

The reproduction control unit 37 can generate a timeline scenario as reproduction control information for application of effect processing to an object selected in a 3D strobe image to control reproduction of the free viewpoint data in accordance with the reproduction control information, as described above.

As described above, the reproduction-and-editing device 13 generates reproduction control information in response to an operation on a 3D strobe image to control reproduction of the moving image content of free viewpoint data in accordance with the reproduction control information. Thus, the user can easily perform reproduction-and-editing work. For example, the user can easily search for a desired scene showing a desired object without repeating a time search and a spatial search.

The user can further perform various pieces of reproduction-and-editing work with operations on the 3D strobe image.

In addition, for reproduction-and-editing work, it is unnecessary to provide GUIs for a time search and a spatial search, other than the 3D strobe image. Furthermore, it is unnecessary to display a plurality of frames of the free viewpoint image side by side. Thus, achieved can be reduction of a space (display screen) required for the reproduction-and-editing work. As a result, for example, even in a case where a small display screen of such a mobile terminal as a smartphone is used, reproduction-and-editing work can be performed easily.

<Description of Computer with Present Technology Applied>

Next, the flow of the processing described above can be performed by hardware or software. In a case where the flow of processing is performed by software, a program included in the software is installed, for example, on a general-purpose computer.

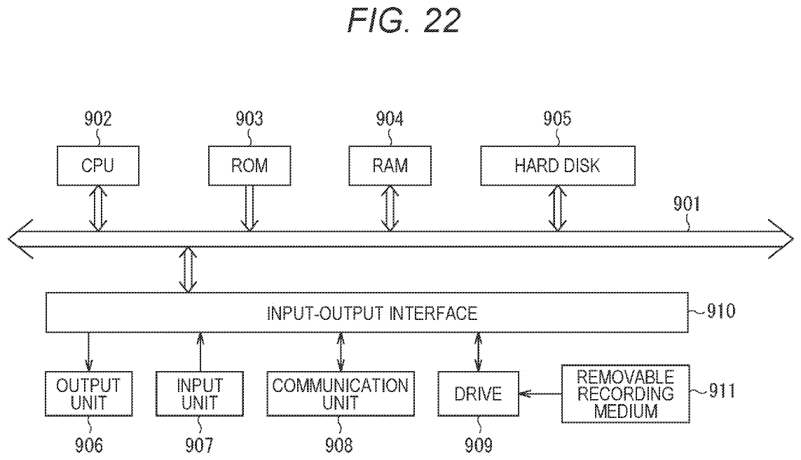

FIG. 22 is a block diagram of an exemplary configuration of an embodiment of a computer on which the program for execution of the flow of the processing described above is installed.

The program can be pre-recorded in a hard disk 905 or a read only memory (ROM) 903 as a recording medium built in the computer.

Alternatively, the program can be stored (recorded) in a removable recording medium 911 driven by a drive 909. Such a removable recording medium 911 can be provided as so-called package software. Here, examples of the removable recording medium 911 include a flexible disk, a compact disc read only memory (CD-ROM), a magneto optical (MO) disc, a digital versatile disc (DVD), a magnetic disk, and a semiconductor memory.

Note that in addition to such installation on the computer from the removable recording medium 911 as described above, the program can be downloaded to the computer through a communication network or a broadcast network and can be installed in the built-in hard disk 905. In other words, for example, the program can be wirelessly transferred from a download site to the computer through an artificial satellite for digital satellite broadcasting, or can be wiredly transferred to the computer through a network such as a local area network (LAN) or the Internet.

The computer has a built-in central processing unit (CPU) 902, and an input-output interface 910 is connected to the CPU 902 through a bus 901.

When the user, for example, operates an input unit 907 and a command is input through the input-output interface 910, the CPU 902 executes the program stored in the read only memory (ROM) 903 in accordance with the command. Alternatively, the CPU 902 loads the program stored in the hard disk 905 into a random access memory (RAM) 904 to execute the program.

As a result, the CPU 902 performs the processing following the above flowcharts or the processing performed by the configurations of the above block diagrams. Then, the CPU 902 causes an output unit 906 to output the result of the processing or a communication unit 908 to transmit the result of the processing, and further causes, for example, the hard disk 905 to record the result of the processing through, for example, the input-output interface 910, as necessary.

Note that the input unit 907 includes, for example, a keyboard, a mouse, and a microphone. In addition, the output unit 906 includes, for example, a liquid crystal display (LCD) and a speaker.

Here, in the present specification, the processing executed by the computer following the program does not necessarily need to be performed chronologically in the orders described as the flowcharts. In other words, the processing executed by the computer in accordance with the program also includes processing executed parallelly or separately (for example, parallel processing or processing with objects).

In addition, the program may be processed by one computer (processor) or may be subjected to distribution processing by a plurality of computers. Furthermore, the program may be transferred to a distant computer and executed.

Still furthermore, in the present specification, the system means a collection of a plurality of constituent elements (e.g., devices and modules (components)), and thus it is unconcerned whether or not all the constituent elements are provided in the same casing. Therefore, a plurality of devices housed in separate casings and connected through a network, and one device having a plurality of modules housed in one casing are both systems.

Note that the embodiment of the present technology is not limited to the above embodiment, and thus various modifications can be made within the scope without departing from the gist of the present technology.

For example, the present technology can adopt a cloud computing configuration in which one function is shared and processed by a plurality of devices through a network.

In addition, each step described in the above flowcharts can be performed by one device, or can be performed by sharing among a plurality of devices.

Furthermore, in a case where a plurality of pieces of processing is included in one step, the plurality of pieces of processing included in the one step can be performed by one device, or can be performed by sharing among a plurality of devices.

In addition, the effects described in the present specification are merely exemplified and are not intended to be limiting; thus, there may have additional effects.

Note that the present technology can adopt the following configurations.

<1>

An image processing apparatus, including:

a reproduction control unit configured to generate reproduction control information for control of reproduction of free viewpoint data generated from a plurality of viewpoint images in response to an operation on a three-dimensional (3D) strobe image including a strobe model viewed from a virtual viewpoint, in which, in the strobe model, 3D models of objects at a plurality of times being generated from the plurality of viewpoint images shot from a plurality of viewpoints are disposed in a three-dimensional space.

<2>

The image processing apparatus according to <1>,

in which the reproduction control unit further controls the reproduction of the free viewpoint data in accordance with the reproduction control information.

<3>

The image processing apparatus according to <1> or <2>,

in which the reproduction control unit generates the reproduction control information for start of the reproduction with a frame showing an object selected in the 3D strobe image.

<4>

The image processing apparatus according to any of <1> to <3>,

in which the reproduction control unit generates the reproduction control information for start of the reproduction with a frame showing an object selected in the 3D strobe image and for end of the reproduction at a frame showing another object selected in the 3D strobe image.

<5>

The image processing apparatus according to any of <1> to <4>,

in which the reproduction control unit generates the reproduction control information for deletion from a frame showing an object selected in the 3D strobe image to a frame showing another object selected in the 3D strobe image.

<6>

The image processing apparatus according to any of <1> to <5>,

in which the reproduction control unit generates the reproduction control information for jump of the reproduction from a frame showing an object selected in the 3D strobe image to a frame showing another object selected in the 3D strobe image.

<7>

The image processing apparatus according to <6>,

in which the reproduction control unit generates the reproduction control information for jump of the reproduction from the frame showing the object selected in the 3D strobe image of predetermined moving image content to the frame showing the another object selected in the 3D strobe image of another piece of moving image content.

<8>

The image processing apparatus according to any of <1> to <7>,

in which the reproduction control unit generates the reproduction control information for link of an object selected in the 3D strobe image with predetermined data.

<9>

The image processing apparatus according to any of <1> to <8>,

in which the reproduction control unit generates the reproduction control information for application of effect processing to an object selected in the 3D strobe image.

<10>

An image processing method, including:

generating reproduction control information for control of reproduction of free viewpoint data generated from a plurality of viewpoint images in response to an operation on a three-dimensional (3D) strobe image including a strobe model viewed from a virtual viewpoint, in which, in the strobe model, 3D models of objects at a plurality of times being generated from the plurality of viewpoint images shot from a plurality of viewpoints are disposed in a three-dimensional space.

<11>

A computer program for causing a computer to function as a reproduction control unit that generates reproduction control information for control of reproduction of free viewpoint data generated from a plurality of viewpoint images in response to an operation on a three-dimensional (3D) strobe image including a strobe model viewed from a virtual viewpoint, in which, in the strobe model, 3D models of objects at a plurality of times being generated from the plurality of viewpoint images shot from a plurality of viewpoints are disposed in a three-dimensional space.

### REFERENCE SIGNS LIST

11 Shooting device
12 Content server
13 Reproduction-and-editing device
21 Free-viewpoint-data generation unit
22 Strobe-model generation unit
23 Storage unit
24, 31 Communication unit
32 Storage unit
33 Free-viewpoint-image generation unit
34 Display unit
35 Virtual-viewpoint setting unit
36 Operation unit
37 Reproduction control unit
38 Storage unit
901 Bus
902 CPU
903 ROM
904 RAM
905 Hard disk
906 Output unit
907 Input unit
908 Communication unit
909 Drive
910 Input-output interface
911 Removable recording medium

1. An image processing apparatus, comprising:
a reproduction control unit configured to generate reproduction control information for control of reproduction of free viewpoint data generated from a plurality of viewpoint images in response to an operation on a three-dimensional (3D) strobe image including a strobe model viewed from a virtual viewpoint, wherein, in the strobe model, 3D models of objects at a plurality of times being generated from the plurality of viewpoint images shot from a plurality of viewpoints are disposed in a three-dimensional space.

2. The image processing apparatus according to claim 1,
wherein the reproduction control unit further controls the reproduction of the free viewpoint data in accordance with the reproduction control information.

3. The image processing apparatus according to claim 1,
wherein the reproduction control unit generates the reproduction control information for start of the reproduction with a frame showing an object selected in the 3D strobe image.

4. The image processing apparatus according to claim 1,
wherein the reproduction control unit generates the reproduction control information for start of the reproduction with a frame showing an object selected in the 3D strobe image and for end of the reproduction at a frame showing another object selected in the 3D strobe image.

5. The image processing apparatus according to claim 1,
wherein the reproduction control unit generates the reproduction control information for deletion from a frame showing an object selected in the 3D strobe image to a frame showing another object selected in the 3D strobe image.

6. The image processing apparatus according to claim 1,
wherein the reproduction control unit generates the reproduction control information for jump of the reproduction from a frame showing an object selected in the 3D strobe image to a frame showing another object selected in the 3D strobe image.

7. The image processing apparatus according to claim 6,
wherein the reproduction control unit generates the reproduction control information for jump of the reproduction from the frame showing the object selected in the 3D strobe image of predetermined moving image content to the frame showing the another object selected in the 3D strobe image of another piece of moving image content.

8. The image processing apparatus according to claim 1,
wherein the reproduction control unit generates the reproduction control information for link of an object selected in the 3D strobe image with predetermined data.

9. The image processing apparatus according to claim 1,
wherein the reproduction control unit generates the reproduction control information for application of effect processing to an object selected in the 3D strobe image.

10. An image processing method, comprising:
generating reproduction control information for control of reproduction of free viewpoint data generated from a plurality of viewpoint images in response to an operation on a three-dimensional (3D) strobe image including a strobe model viewed from a virtual viewpoint, wherein, in the strobe model, 3D models of objects at a plurality of times being generated from the plurality of viewpoint images shot from a plurality of viewpoints are disposed in a three-dimensional space.

11. A computer program for causing a computer to function as a reproduction control unit that generates reproduction control information for control of reproduction of free viewpoint data generated from a plurality of viewpoint images in response to an operation on a three-dimensional (3D) strobe image including a strobe model viewed from a virtual viewpoint, wherein, in the strobe model, 3D models of objects at a plurality of times being generated from the plurality of viewpoint images shot from a plurality of viewpoints are disposed in a three-dimensional space.
